(19) United States
(12) Patent Application Publication
(10) Pub. No.: US 2016/0261606 A1
(43) Pub. Date: Sep. 8, 2016

(54) LOCATION-BASED NETWORK SECURITY

(71) Applicant: Fortinet, Inc., Sunnyvale, CA (US)

(72) Inventor: MARTÍN HUMBERTO HOZ SALVADOR, Metepec (MX)

(73) Assignee: Fortinet, Inc., Sunnyvale, CA (US)

(21) Appl. No.: 15/156,220

(22) Filed: May 16, 2016

Related U.S. Application Data
(62) Division of application No. 14/578,835, filed on Dec. 22, 2014.

(51) Int. Cl. H04L 29/06

(52) U.S. Cl. CPC H04L 63/107; H04L 63/02; H04L 63/08

(57) ABSTRACT

Methods and systems for a location-aware network security device are provided. According to one embodiment, a resource access request is received at a network security device of a protected network from a user device. The resource access request represents a request to access a resource of the protected network. A geographical location of the user device is determined by the network security device. The network security device then determines whether the user device should be allowed access to the resource by evaluating a location-specific security rule defined for the resource and the determined geographical location.

### CROSS-REFERENCE TO RELATED APPLICATIONS

This application is a continuation of U.S. patent application Ser. No. 14/578,835, filed Dec. 22, 2014, which is hereby incorporated by reference in its entirety for all purposes.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever. Copyright © 2014-2016, Fortinet, Inc.

### BACKGROUND

1. Field

Embodiments of the present disclosure generally relate to a rule-based network firewall. In particular, various embodiments relate to methods and systems for providing a location-aware firewall and/or a network security/gateway device that can authorize and/or deny access of a secured resource to a requester/user based on one or more rules related to physical location and/or IP address tagged geo-location of the user's device.

2. Description of the Related Art

Recent development of mobile Internet on portable devices such as mobile phones, smart phones, PDAs, communicators, tablet PCs, intelligent telecommunication devices, among other like devices, has enabled users to consume content on the move when compared with traditional laptop and desktop computers, where the location of user was typically static in nature. Access of content by these mobile devices when they are at a location which unknown and potentially risky to the data being handled, raises a major concern in the context of sensitive data, services, and secure network resources, wherein with such data being confidential and controlled, a serious threat is posed in front of key stakeholders such as Corporates, Govt. establishments, and business establishments to secure access to such information and control who/when/where accesses the same. Mobile devices can attempt connection with one or more resources by connecting with the Internet and making requests over Wi-Fi, Bluetooth, Zigbee, or through a cellular network using, for example, 2G, 3G or 4G technologies, where the resources may or may not be behind a firewall or like network security device that regulates data traffic between different networks and prevents transmitting and/or receiving inadequate access, unauthorized or harmful between a mobile device/personal computer, a home or corporate network and an Internet connection.

Similarly, there may be certain data and/or services that a data provider and/or a service provider does not want to be accessible to a user device outside a particular geographical area such as outside the office premises, or outside the city boundary, or outside the state boundary or outside the national boundary, or may want the restrictions to be imposed even within office boundaries or based on other location-based factors like the type of location from where the data is being used, such as public places (stadiums, hotels, restaurants, airports), or semi-public places (partner or customer offices) or private areas (homes), where some of them might be potentially risky to certain type of data. In the past, computing devices such as desktop computers were used to access network resources and these device were physically static in nature, and therefore it was relatively simpler to define permissions on these devices and locate these devices to ensure compliance.

In prior art solutions, a network such as a corporate network or a university network is typically created for interconnected computing devices having some sort of commonality to allow access of data and/or services by these devices within the defined network. In such instance, the network generally permits communication or signal exchange among the various computing systems of the common group in some selectable way, wherein interconnection of these computing systems, as well as devices that regulate and facilitate exchange among the systems, represents a defined network. For instance, a network of an establishment can be created for access of data and/or services by authorized devices within the defined network, wherein requests for access to sensitive data and network resources by any device that comes from out of the defined network is denied. With more users nowadays using mobile/portable communication devices to access/control/manage information, concerns over authentication and/or authorization of users to enable access to networks/services/applications has increased significantly, wherein the security can not only be defined based on source device IP address rules, but also depends significantly on the identity of the user, the type of device being used, where the device is present, among other like parameters.

Existing methods used for defining security rules on network security devices such as firewalls primarily focus on IP addresses of source devices, protocols being used (such as Transmission Control Protocol (TCP), User Datagram Protocol (UDP), Internet Control Message Protocol (ICMP), among others), characteristics of incoming packets, source/destination port information (such as for TCP or UDP connections), among other like parameters. These methods were sufficient while the requesting terminals were static in nature, i.e., the requesting devices/terminals had static Internet Protocol (IP) addresses. However, with the advent of mobile devices that have varying IP addresses depending on their location-based attributes, it has become difficult to accurately predict whether an incoming request for secured network resource access should be accepted.

There is therefore a need for systems and methods for configuring a network security device that can filter/process incoming requests for access to secured data, resources, and/or services through one more security rules that are based on a physical location of the requesting device to ensure that the connection is originated from a source or a physical place that is trusted.

### SUMMARY

Methods and systems are described for a location-aware network security device. According to one embodiment, a resource access request is received at a network security device of a protected network from a user device. The resource access request represents a request to access a resource of the protected network. A geographical location of the user device is determined by the network security device. The network security device then determines whether the user device should be allowed access to the resource by evaluating a location-specific security rule defined for the resource and the determined geographical location.

Other features of embodiments of the present disclosure will be apparent from accompanying drawings and from detailed description that follows.

### BRIEF DESCRIPTION OF THE DRAWINGS

In the Figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIGS. 1A and 1B illustrate exemplary firewall configurations for protection of network resources.

FIG. 2 illustrates an exemplary network architecture in accordance with an embodiment of the present disclosure.

FIG. 3 illustrates exemplary functional modules of a location-based network access system in accordance with an embodiment of the present disclosure.

FIG. 4A illustrates communications among a user device, a firewall and a secured resource in accordance with an embodiment of the present disclosure.

FIG. 4B illustrates communications among a user device, a firewall and a secured resource in accordance with another embodiment of the present disclosure.

FIG. 5 illustrates an exemplary logical table showing authorization status of multiple resource access requests based on their location in accordance with an embodiment of the present disclosure.

FIG. 6 illustrates an exemplary location based security rule configuration for secured network resources in accordance with an embodiment of the present disclosure.

FIG. 7 is a flow diagram illustrating resource access request processing in accordance with an embodiment of the present disclosure.

FIG. 8 is a flow diagram illustrating resource access request processing in accordance with another embodiment of the present disclosure.

FIG. 9 is an exemplary computer system in which or with which embodiments of the present invention may be utilized.

### DETAILED DESCRIPTION

Methods and systems are described for a location-aware network security device. In the following description, numerous specific details are set forth in order to provide a thorough understanding of embodiments of the present disclosure. It will be apparent to one skilled in the art that embodiments of the present disclosure may be practiced without some of these specific details.

Embodiments of the present disclosure include various steps, which will be described below. The steps may be performed by hardware components or may be embodied in machine-executable instructions, which may be used to cause a general-purpose or special-purpose processor programmed with the instructions to perform the steps. Alternatively, steps may be performed by a combination of hardware, software, firmware and/or by human operators.

Embodiments of the present disclosure may be provided as a computer program product, which may include a machine-readable storage medium tangibly embodying thereon instructions, which may be used to program a computer (or other electronic devices) to perform a process. The machine-readable medium may include, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware).

Various methods described herein may be practiced by combining one or more machine-readable storage media containing the code according to the present disclosure with appropriate standard computer hardware to execute the code contained therein. An apparatus for practicing various embodiments of the present disclosure may involve one or more computers (or one or more processors within a single computer) and storage systems containing or having network access to computer program(s) coded in accordance with various methods described herein, and the method steps of the disclosure could be accomplished by modules, routines, subroutines, or subparts of a computer program product.

If the specification states a component or feature “may”, “can”, “could”, or “might” be included or have a characteristic, that particular component or feature is not required to be included or have the characteristic.

Embodiments of the present disclosure generally relate to a rule-based network firewall, and in particular, various embodiments relate to methods and systems for providing a location-aware firewall and/or a network security/gateway device that can authorize and/or deny access to a secured resource by a requester/user based on one or more rules related to the physical location and/or IP address tagged geo-location of the user's device.

Exemplary embodiments will now be described more fully hereinafter with reference to the accompanying drawings, in which exemplary embodiments are shown. This disclosure may, however, be embodied in many different forms and should not be construed as limited to the embodiments set forth herein. These embodiments are provided so that this disclosure will be thorough and complete and will fully convey the scope of the disclosure to those of ordinary skill in the art. Moreover, all statements herein reciting embodiments of the disclosure, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, schematics, illustrations, and the like represent conceptual views or processes illustrating systems and methods embodying this disclosure. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this disclosure. Those of ordinary skill in the art further understand that the exemplary hardware, software, processes, methods, and/or operating systems described herein are for illustrative purposes and, thus, are not intended to be limited to any particular named element.

According to one embodiment, a method is provided for implementing a location-aware network security device, where the method includes the steps of receiving, at the network security device of a protected network, a resource access request from a user device to access a resource of the protected network, determining, by means of the network security device, geographical location of the user device, and evaluating, by means of the network security device, as to whether the user device should be allowed access to the resource based on a location-specific security rule defined for the resource and the determined geographical location. According to one embodiment, the geographical location of the user device can be determined based on a location request sent by the network security device to the user device requesting geographical coordinates of the user device using a system such as Global Positioning System (GPS), GLONASS, Galileo or similar. According to another embodiment, the geographical location of the user device can be automatically and/or manually determined and/or determined based on a defined configuration, sent by the user device along with or separate from the resource access request. According to one embodiment, the user device can be configured to periodically send keep-alive messages to the network security device to enable continuous reevaluation of location-specific security rules by the network security device, wherein the keep-alive messages can include information regarding the current geographic location of the user device.

According to one embodiment, location-specific security rules implemented by the network security device each include one or more conditions for allowing access to the resource based on one or a combination of a country from which the resource access request is issued, a state from which the resource access request is issued, a city from which the resource access request is issued, a type of establishment from which the resource access request is issued, a rate of change of location of the user device, a density of people in which the user device is currently located, a distance of a location from which the resource access request is issued from a defined location, GPS coordinates of the user device, among other like factors/attributes. According to one embodiment, the geographical location of the user device can be determined based on one or a combination of triangulation, GPS and geo-location mapped Internet Protocol (IP) addresses. In one embodiment, when the geographical location of the user device is not available or is not determinable, the network security device can be configured to deny access the user device to the requested resource.

According to another embodiment, a location-based network security system includes a request receive module configured to receive a resource access request from a user device relating to a resource within a protected network that is protected by the location-based network security system. The network security system can further include a location determination module configured to determine a geographical location of the user device and a request-based rule retrieval module configured to retrieve a location-specific security rule for the resource to be accessed. The network security system can further include a location-based authorization module configured to authenticate the resource access request based on processing of a location-specific security rule associated with the determined geographical location, and a resource access module configured to enable access to the resource by the user device based on an affirmative authentication of the resource by the location-based authorization module.

According to one embodiment, the geographical location of user device can be determined based on a location request sent by the network security device to the user device asking for Global Positioning System (GPS) (or similar system like GLONASS or Galileo) coordinates of the user device. Alternatively, the geographical location of the user device can be proactively sent by the user device concurrently with the resource access request.

According to one embodiment, the geographical location of a user device can be retrieved by an application installed on the user device that is configured to retrieve and send the geographical location to the network security device. The application can further be configured to authenticate the user of the user device before sending the geographical location to the network security device.

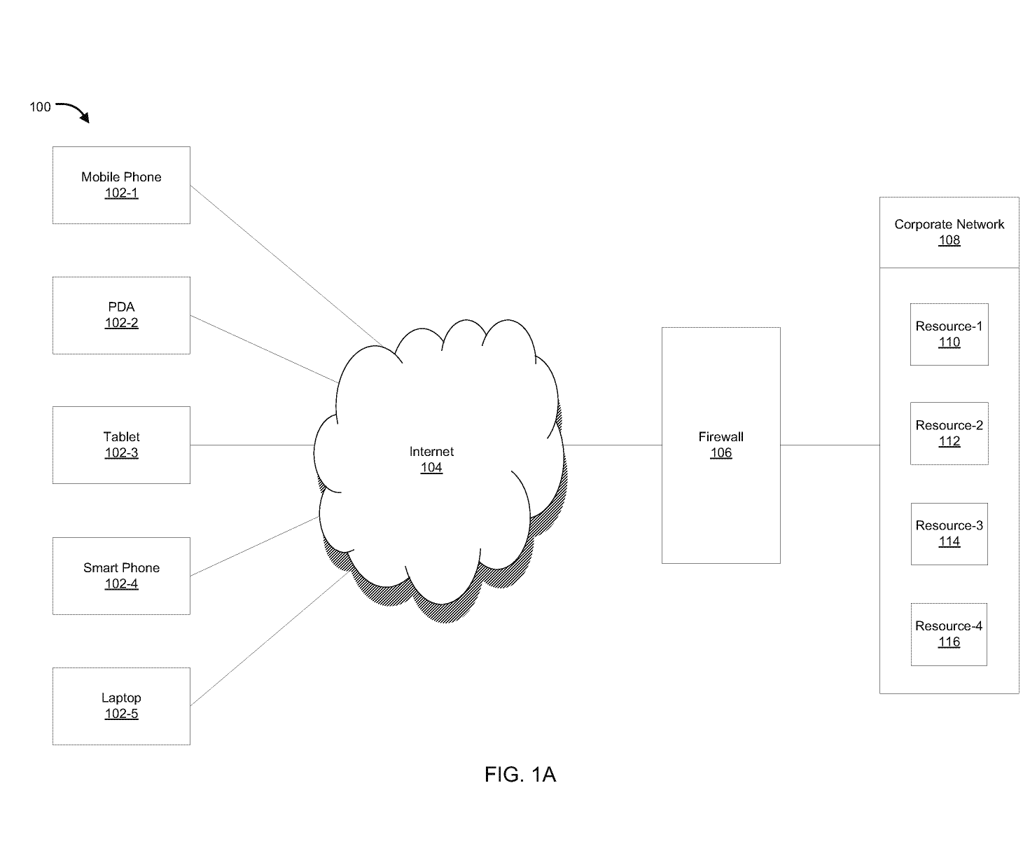

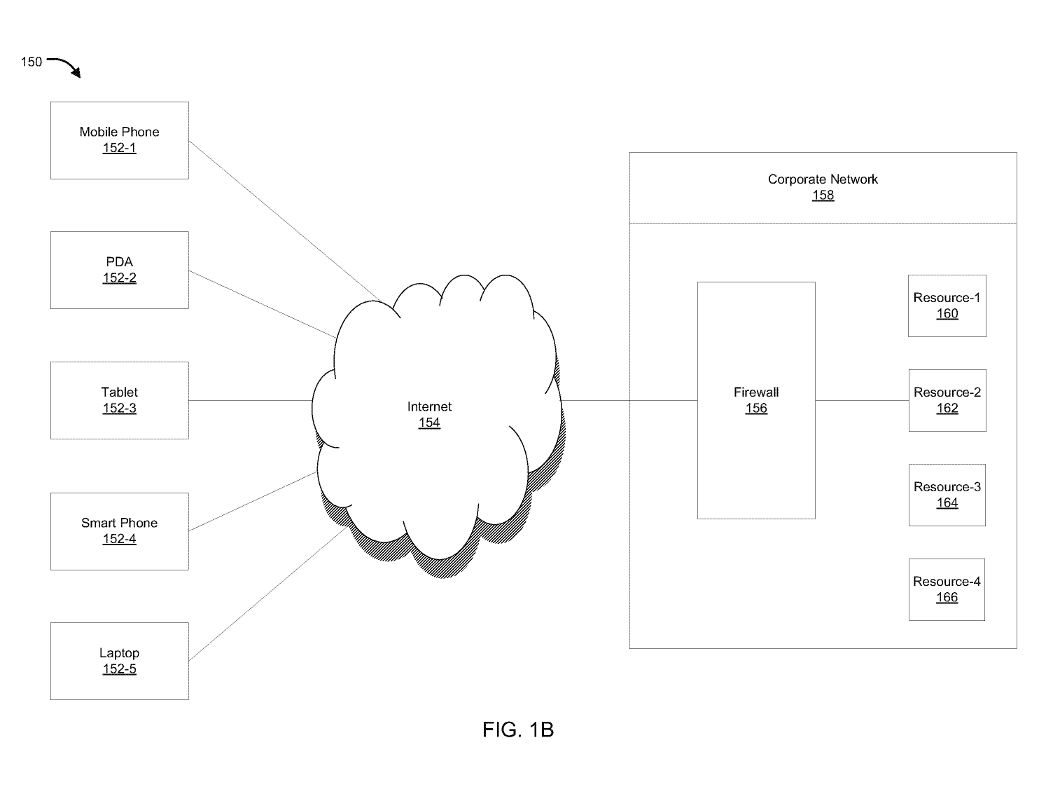

FIGS. 1A and 1B illustrate exemplary firewall configurations 100 and 150 respectively for protection of network resources. Those skilled in the art will appreciate that various other configurations, network architectures and/or network security devices may be employed depending upon the particular implementation. For example, a network security device may include, but is not limited to, a firewall, a gateway, a Unified Threat Management (UTM) appliance, a Next Generation Firewall (NGFW) device, an intrusion prevention system (IPS), an intrusion detection system (IDS) and the like in the form of one or more physical or virtual devices.

As illustrated in FIG. 1A, architecture/configuration 100 can include one or more user devices 102-1, 102-2, 102-3, 102-4, and 102-5, which may be collectively and interchangeably referred to as user devices 102, or computing devices 102, client devices 102, or simply as devices 102 hereinafter. User devices 102 can include a variety of computing devices, including, but not limited to, computers, tablets, smartphones, smart watches, wearable devices, among others, which are capable of making resource access requests for accessing information/data/content present within a given network (including a Content Delivery Network (CDN), a public network, a private network, the Internet, an Intranet, an Extranet, an enterprise network or other network configuration). The information/data/content may include, but is not limited to, web objects (e.g., text, graphics and scripts), downloadable objects (e.g., media files, software, documents), applications (e.g., databases, e-commerce, portals), live streaming media, on-demand streaming media, social networks, articles, papers, blogs, email, files, folders, among various other types of network-accessible resources. Such a resource access request can be made by any user device 102 to a network (e.g., corporate network 108) having one or more protected/unprotected resources 110, 112, 114, and 116. The request can be made to corporate network 108 through one or more intermediate networks, such as the Internet 104, where the resources can be protected by a network security device (e.g., firewall 106) to enable controlled/authenticated/authorized access to the one or more resources.

According to one embodiment, unprotected resources may be accessible to the public at large and therefore may not need authentication and/or evaluation to be performed by firewall 106, whereas protected resources, on the other hand, may require authentication/authorization to be performed for each incoming request or on a session-by-session basis based on one or a combination of user device attributes, IP address attributes, request location attributes, requesting user attributes, login credentials, among other attributes/factors/parameters that form part of the present disclosure by the configured one or more network security devices.

Those skilled in the art will appreciate that although, in the illustrated representations of network configuration/architectures shown in FIG. 1A and 1B, a firewall is shown as an exemplary network security device, embodiments of the present invention may be used in connection with a variety of other rule-based network security devices and/or incoming request processing/resource access devices. For example, embodiments of the present invention are thought to have applicability to network security devices including, but not limited to, firewalls, gateways, UTM or NGFW appliances, IPSs, IDSs and the like in the form of one or more physical or virtual devices.

FIG. 1B illustrates another exemplary architecture layout of a network configuration showing one or more user/computing devices, such as 152-1, 152-2, 152-3, 152-4, and 152-5, which may be collectively referred to as user devices or computing devices or simply as devices 152 hereinafter. As can be seen, in the configuration of FIG. 1B, instead of the network security device, such as firewall 156, being placed outside the corporate network (as in FIG. 1A), the firewall 156 has been configured within the corporate network 158 so that it can monitor/control/process incoming requests pertaining only to resources 160-166 of the corporate network 158 and not resources outside the company network 158.

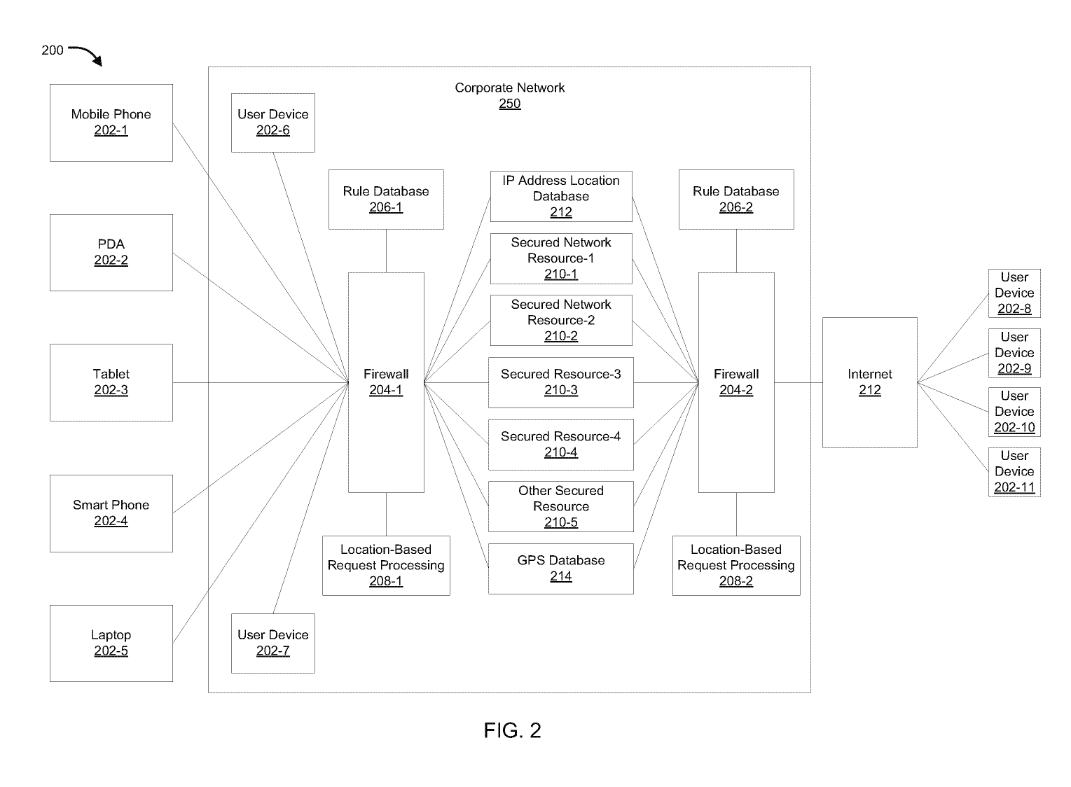

FIG. 2 illustrates an exemplary network architecture 200 in accordance with an embodiment of the present disclosure. As network architecture 200 is exemplary in nature and is used merely to illustrate various aspects of the present disclosure, those skilled in the art will appreciate various other configurations are possible depending upon the particular implementation. According to one embodiment, one or more user devices (e.g., a mobile phone 202-1, a personal digital assistant (PDA) 202-2, a tablet 202-3, a smartphone 202-4, and a laptop 202-5, which may be collectively referred to as user devices 202 or computing devices 202 or simply as devices 202 hereinafter, may be located proximate to corporate network 250 and are capable of issuing resource access requests to network security device (e.g., firewall 204) of network 250. Another set of user devices (e.g., devices 202-8, 202-9, 202-10, and 202-11, which may be collectively referred to as devices 202 hereinafter, can be configured such that their resource access requests are made through Internet 212 to reach firewall 204-2. In the context of the present example, another set of user devices 202-6 and 202-7 are shown positioned within the corporate network 250 itself.

According to one embodiment, firewall 204 (including but not limited to firewall 204-1 and 204-2) can be operatively coupled with rule databases 206-1 and 206-2, which may be collectively referred to as rule database 206 hereinafter, and with location-based request processing sub-systems/modules 208-1 and 208-2, which may be collectively referred to as location-based request processing sub-system/module 208 hereinafter. Rule database 206 may be a database separate and apart from firewall 204 within the corporate network 206-1, may be integrated within firewall 204 or may be remotely located. Rule database 206 can be configured to store one or more rules the define the conditions under which access to secured network resources 210-1, 210-2, . . . , 210-n is allowed or not allowed. Secured network resources 210-1, 210-2, . . . , 210-n may be collectively referred to as secured network resources 210 hereinafter. As mentioned above, of the resources/files/folders/items/content 210 that form part of the corporate network 250 that are intended to be accessed through resource access requests from one or more devices 202, some of the resources may be protected by firewall 204, whereas others may be unprotected and hence accessible to any device attempting to access them. Those skilled in the art will appreciate that properties/attributes of corporate network resources may be updated/changed to change the manner or conditions under which they are accessible. Each rule of rule database 206 is typically associated with at least one network resource 210 and defines the manner/time/duration/mode in which the concerned resource 210 can be accessed. The rule can also define who can access the resource in context, when the resource can be accessed, type of rights (such as read, write, read/write) on each access, duration of access, device(s) that can access the resource 210, locations from which the resource can be accessed, among other like parameters/attributes.

According to an embodiment, location-based request processing sub-system/module 208 can be configured to receive/extract/retrieve the location from an incoming resource access request made by a requesting user/user device 202 and process the incoming resource access request based on the identified location and one or more located-based rules associated with the requested resource. For instance, when a secured network resource 210-4 is intended/desired to be accessed by user device 202-1, one or more rules corresponding to network resource 210-4 can be extracted and processed along with the location of the device 202-1 to evaluate/determine if the device 202-1 should be allowed access to the device 202-1. For instance, a location-based rule may limit access to network resource 210-4 to devices that are within a range of 5 miles. In another instance, the rule may limit access to network resource 210-4 to devices that are within the state of California. Similarly, the rule can also state that only devices that are within a defined range of GPS coordinates should be allowed access. Based on the disclosure provided herein, those skilled in the art will appreciate a variety of location specific rules can be defined by an administrator/user so as to implement the desired security policy for the enterprise. According to one embodiment, the rule can also exclude location specific conditions and be specific with respect to other parameters, such as the IP address(es), for example, of device(s) permitted to have access and therefore, in such a case, the location of the user would not make a difference in evaluating accessibility of the resource.

According to one embodiment, firewall 204 can also be operatively coupled with a GPS database 214 that is configured to store/update/modify GPS coordinates of user devices 202 that make various resource access requests. The database can be configured/designed in any desired manner such as, for instance, a log of all requests for a given resource can be stored in a single repository/table, or all requests made in a given time range irrespective of the resource being accessed can be stored, and therefore all such data structures and organization of the database 214 is completely within the scope of the present disclosure. According to one embodiment, GPS database 214 can include known coordinates of at least country boundaries and can also include narrowed down coordinates at city/state/district/street levels. Wherever possible, this can be detailed down to state and county level. A potential variant can be gathering place information from existing third-party location databases such as Google Maps, Waze, or FourSquare, wherein cross-referencing this to third party databases can increase the granularity of the proposed system. GPS database 214 can be a third-party location database or one that is proprietary to the enterprise at issue. GPS database 214 may also be integrated within firewall 204 or remotely located—it simply needs to be available to be queried by the location-aware network security device as needed to determine information or characteristics regarding a location at issue.

Those skilled in the art will appreciate there are a variety of ways of obtaining location information regarding a user device. Depending upon the particular implementation, for example, the location of the user device 202 may be proactively sent by user device 202 concurrently with the resource access request or the location may be requested by firewall 204 responsive to receipt of the resource access request. Various forms of location identifying information may be used as well. For instance, in addition to or instead of GPS coordinates, other means, including, but not limited to, triangulation and geo-location mapped Internet Protocol (IP) addresses or additional GPS-like systems such as GLONASS or Galileo may also be supported.

In some embodiments, as device 202 may be moving during a resource access, device 202 may be configured to periodically send its current location coordinates to firewall 204 (or firewall 204 may periodically request current location coordinates of device 202) so as to allow firewall 204 to continuously reevaluate whether device 202 meets the access conditions specified by the location-specific rule(s) associated with the resource at issue.

According to another embodiment, firewall 204 can also be configured/operatively coupled with an IP address location database 212, which can be configured to store the IP address of the requesting user device 202 along with the location coordinates of the device 202. One should appreciate that instead of or along with the actual coordinates, area/city/district/state/locality/country/continent of the requesting device can also be stored and represented in a desired manner. Database 212/214 can also indicate the location status of each requesting user device 202 in real time along with the status of its session connection and resource access. As would be appreciated, any change in the location-specific resource access rule can impact the manner/mode/type/attributes of the resource access, and therefore databases 212 and/or 214 can be configured to update themselves with IP address and/or location specific details of requesting user devices 202. Database 212 can further include updated Geo-location information for given IP address network ranges such that based on the IP address, the proposed system can indicate the country/city/state that the connection is originating from.

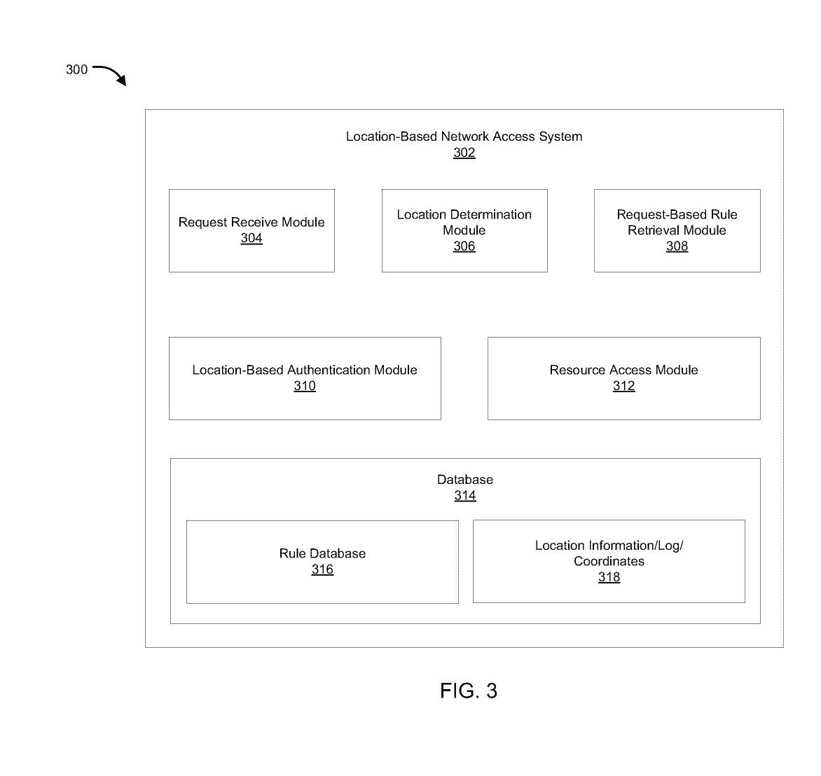

FIG. 3 illustrates exemplary functional modules 300 of a location-based network access system 302 in accordance with an embodiment of the present disclosure. In the context of the present example, location-based network access system 302 includes a request receive module 304, a location determination module 306, a request-based rule retrieval module 308, a location-based authentication module 310 and a resource access module 312. Location-based network access system 302 may further include a database 314 having a rule database 316 (e.g., database 206 of FIG. 2) and a location information/log/coordinates 318. One or more of the other databases discussed with reference to FIG. 2 may also be included within location-based network access system 302. Alternatively, such databases/logs/repositories can be configured within/outside/partially within location-based network access system 302 as appropriate for the particular implementation.

According to one embodiment, request receive module 304 can be configured to receive a resource access request from a user device relating to a resource within a protected network that is protected by location-based network security system 302. As mentioned earlier, the request may be accompanied by location information (e.g., location coordinates) of the device making the request or responsive to receiving the resource access request, location-based network access system 302 may request such location information be provided by the user device. In an embodiment, the resource access request may be made by means of an application installed/configured on the user device. This application may be configured to augment legacy resource access requests with location information, for example, by encapsulating legacy resource access requests with location information or by appending location information thereto.

According to one embodiment, location determination module 306 can be configured to determine a geographical location of the user device. In an exemplary implementation, the request receive module 304 as well as the location determination module 306 along with one or more other functional modules described herein can be configured within a network security device (e.g. a firewall, gateway, IDS/IPS or the like), such that when a resource access request is received, location determination module 306 can retrieve/extract/determine/identify location coordinates of the requesting user device. As described above, such location coordinates can be determined by any means including, but not limited to, one or a combination of triangulation, GPS and geo-location mapped Internet Protocol (IP) addresses. As mentioned above, location coordinates can either be given by the requesting user device along with making the request or can be received by the network security device by a separate request issued by the network security device once the resource access request has been received from the user device. Such an explicit request can be configured to query the user device regarding its exact/estimated location coordinates. In another embodiment, the coordinates may be received by the network security device during a handshake protocol established between the requesting user device and the network security device.

According to one embodiment, request-based rule retrieval module 308 is configured to retrieve one or more location-specific security rules for the requested resource. Such a rule can be retrieved from rule database 316, wherein the rule can define the conditions under which the resource at issue is permitted to be accessed. For instance, the rule can define the type of users, type of user devices, time of access, duration of access per session, location from where the resource can be accessed, manner of access, extent of access (such as read, write, read/write, modify, among others), among other properties that can be associated with the requested resource. Those skilled in the art will appreciate that a given rule can also be applicable to multiple resources and also, a given resource can controlled by multiple rules/sub-rules. For instance, for each resource, different rules such as location-based rules, access-based rules, device-based rules, IP address based rules, can be defined/configured.

Location-based authentication module 310 may be configured to authenticate the resource access request based on processing of the location-specific security rule with respect to the determined geographical location. For example, location-based authentication module 310 may authenticate the resource access request to determine whether the location coordinates of the requesting user device are within the acceptance criteria defined in the location-specific rule associated with the resource at issue. If the rule states that the location of the requesting device must be within the company premises, for example, and the location coordinates indicate that the device/user is outside the premises, the connection may be denied by location-based authentication module 310. In one embodiment, if the location coordinates are not initially available with the resource access request, the requesting device may be temporarily permitted access until the location coordinates are received.

According to another embodiment, location-based network access system 302 can further be configured to store location coordinates received from each user device within a location information log, which may facilitate tracking of location coordinates of each user device and also assist in further analysis of resource access, movement trends of requesting device(s), attributes of requesting user, actions being undertaken on/with the resource, among other like attributes/factors.

Resource access module 312 is configured to enable access to the resource by the user device based on an affirmative authentication by location-based authorization module 310. Resource access module 312 can therefore facilitate establishment of a communication session between the user device and the requested resource, along with performing any other allied action such as recordal of the session, analysis of the session, analysis of the actions performed on the requested/access resource, tracking real-time location coordinates of requesting user device, among other such action.

According to one embodiment, as mentioned above, the geographical location of the user device can be determined based on a location request sent by the network security device to the user device requesting Global Positioning System (GPS) coordinates of the user device. In other embodiments, as mentioned above, the geographical location of the user device can be sent by the user device concurrently with the resource access request or separately.

In one embodiment, a location-specific security rule can include one or more conditions for allowing access to associated resources. For example, a location-specific security rule may require the IP address of the user device to belong to the expected source country and that the GPS coordinates of the user device are within particular authorized physical boundaries. Depending on the granularity of the GPS coordinate database, location-specific security rules can be more complex. The following are non-limiting examples:
If the granularity of the GPS coordinate database is at the country level only, a location-specific security rule may specify “Within the US as origin, this connection is authorized” or “The connection is authorized from every country except Iran, Cuba and Syria”.
If the granularity is down to the county and the city level, an exemplary location-specific security rule may state “Within the Santa Clara county as origin, this connection is authorized” or “Within N Kilometers of the Santa Clara county as origin, this connection is authorized” or “The connection is authorized from every county except San Francisco county”.
If the granularity contains location and classification of places (for example, imported from one or more third party location databases (e.g., Waze, Google Maps or FourSquare), a location-specific rule can be more precise, stating “Within N meters of the Fortinet, Inc. campus, this connection is authorized” or “the connection is authorized from every place except within N meters of a bar or train station.”
Regardless of the granularity of the GPS database, it should be noted that absolute GPS coordinates may be used in various embodiments. If absolute coordinates are used, then it is possible to define a location-specific rule that states, for example, “The connection is authorized within N meters from <a particular GPS coordinate>” or “the connection is authorized from every place except within N meters of <a particular GPS coordinate>.”

In some embodiments, location-specific security rules may authorize a connection based on one or a combination of a country from which the resource access request is issued, a state from which the resource access request is issued, a city from which the resource access request is issued, a type of establishment from which the resource access request is issued, a rate of change of location of the user device, a density of people in which the user device is currently located, a distance of a location from which the resource access request is issued from a defined location, and GPS coordinates of the user device. For instance, a location-specific rule for a given resource can state that only such devices that are moving or have change of location at a rate of less than 10 miles or kilometers per hour can be allowed access, such a rule/condition can be implemented by retrieving location coordinates for the user device at least two times say at a space of 5 seconds, and determining the rate of change of location coordinates, based on which the device can be authenticated/disallowed from accessing the requested resource.

According to another embodiment, in case the geographical location coordinates of the requesting user device are not determinable, the network security device can be configured to, as part of resource access module 312, deny access by the user device to the resource. According to another embodiment, temporary access can be granted in such a case depending on the user, the resource being accessed, requesting user device parameters, his/her privileges/role/responsibility, among other like attributes.

In some embodiments, the geographical location of the user device can be retrieved by a user device application configured to retrieve and send the geographical location to the network security device. Such a user device application can be configured to authenticate a user of the user device before sending the geographical location to the network security device. The user device can further be configured to periodically send keep-alive messages indicating a current geographical location of the user device to enable continuous reevaluation of location-specific security rules by the network security device. In yet another exemplary embodiment, resource access module 312 can further be configured to define parameters of access given to the user device, wherein the parameters comprise one or a combination of privileges given during the access, duration of access, and frequency of keep-alive messages expected, among other like attributes/factors/parameters.

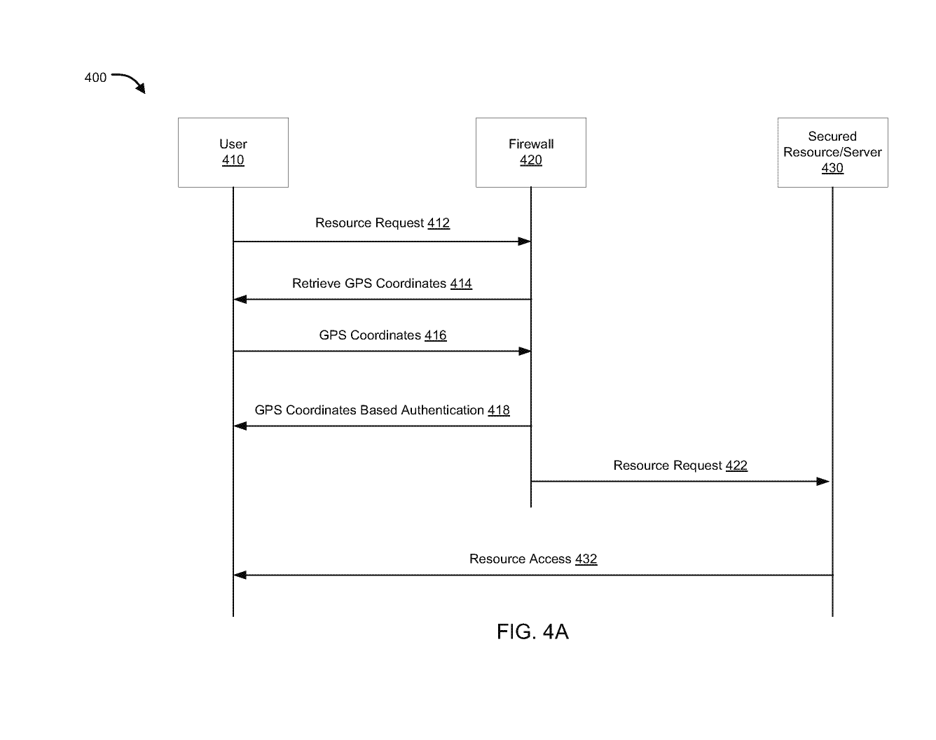

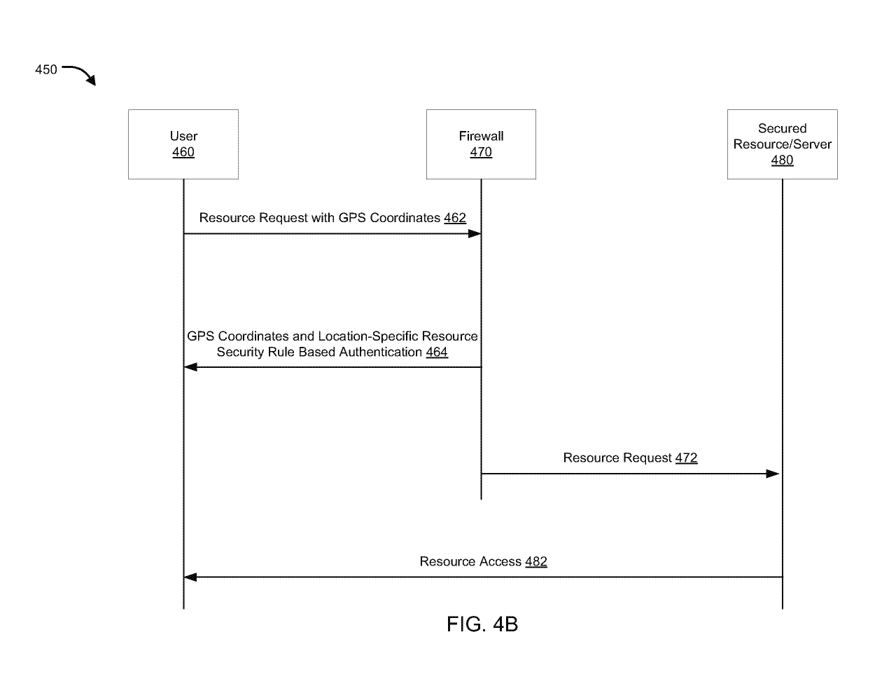

FIG. 4A is a sequence flow diagram 400 showing communications among a user device/user 410, a firewall/security device 420, and a secured resource stored in a server such as 430 in accordance with an embodiment of the present disclosure. In the present example, user 410 can initiate a resource access request 412 to firewall 420, based on which firewall 420 can then, by means of message 414, request the location/GPS coordinates of the requesting user device 410. Such coordinates may not be actual/specific geographic coordinate but can also be represented through more general location information, e.g., location/city/state/country from where the device is making the request. According to one embodiment, location coordinates may be used by firewall 420 to determine one or more attributes of the location from which the request is being made including, but not limited to, density of population in the area (which, for instance, would be higher in a mall when compared with the company premises), kind of location/area (such as mall, movie hall, shopping area, street, industrial area, corporate premises, etc.), type of demographic profile, among other like parameters. Alternatively, the location information provided by the requesting user device may include such attributes. In yet another embodiment, instead of the security device 420 asking for the location coordinates, the user device 410 can itself be configured to send the coordinates each time it sends a resource access request 412.

Based on the flow of FIG. 4A, GPS/location coordinates of the requesting user device 410 can be sent to the security device 420, based on which the device 420 can process one or more location-specific rules and/or general security rules applicable to the resource at issue and then evaluate if the rules allow access to the resource from the location of the requesting user device. When the condition(s) of the rules are satisfied, user device 410 can is authenticated and allowed access to the resource. Post authentication, the resource request can be sent, via message/request/query 422 to secured resource/server 430 and the resource access can be given through 432.

FIG. 4B illustrates another exemplary sequence flow diagram 450 showing communications among a user device/user 460, a firewall/security device 470, and a secured resource stored in a server such as 480 in accordance with an embodiment of the present disclosure. In this example, the user device 460 can send a resource access requests along with the GPS coordinates through message 462 (without waiting for the security device such as 470 to request for the location coordinates). Such GPS coordinates can either be sent in the same resource access request or can be sent automatically/periodically but separate from the resource access request. Instead of being sent periodically or in real-time, the GPS coordinates can also be sent sooner if there is a change in the GPS coordinates of the user device 460 meeting a predetermined or configurable threshold (e.g., 50 meters).

According to one embodiment, firewall 470 can be configured to authenticate the user device 460 based on the received location coordinates and any applicable location-specific rules associated with the resource at issue, and the authentication can then be confirmed/communicated through message 464 back to the user device 460, based on which the user 460 can then communicate with the resource stored on/in the server 480 through interactions such as 472 and 482.

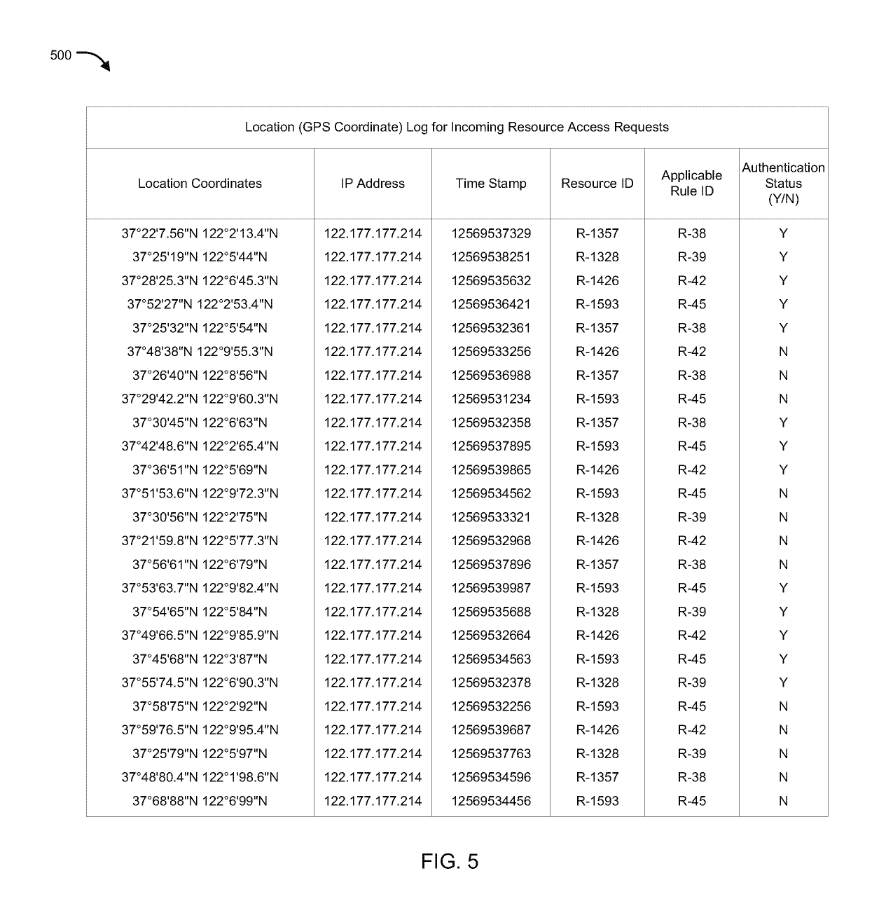

FIG. 5 illustrates an exemplary logical table 500 showing authorization status of multiple resource access requests based on their location in accordance with an embodiment of the present disclosure. One should appreciate that the table structure is completely exemplary in nature and such a table may not even be required to be maintained/constructed. Even if constructed, the table can include any other field or exclude any of the present fields as desired by the company policy/administrator. Therefore, the present table is completely exemplary in nature and merely to illustrate aspects of the present disclosure.

According to one embodiment, in view of FIG. 5, table 500 can include a log of location coordinates of the requesting user devices, IP address of the requesting user devices, timestamp of the resource access request, resource identifier (ID), rule applicable for the requested resource identifier (ID), and the authentication status of each resource access request. As can be seen, the applicable rule for each resource identifier is same, i.e. R-38 is assigned to resource having identifier R-1357 and similarly, R-45 is assigned to resource having identifier R-1593.

In an exemplary implementation, each incoming resource access request can either be accompanied by its IP address and location coordinates or such information can be queried by the network security device such as firewall. In the present illustration, the complete table 500 has been shown for a single user device having an IP address of 122.177.177.214, which is exemplary, and any number user devices and their IP addresses can be included in such a log, wherein the IP addresses can even be dynamically changing based on user device's location. In an instance, for a second resource access request received at a timestamp of 12569538251 attempting to access resource ID R-1328, security device can retrieve the location coordinate of the user device to be 37°25′19″N 122°5′44″N, and can check if the applicable location-specific rule R-39 allows the device having such location coordinates to access the resource R-1328. As seen in the authentication status having status ‘Y’, the current rule location-specific rule R-39 allows the user device to access the resource. When the same device having the same IP address tries to access the same resource R-1328 from a different location coordinate of 37°30′56″N 122°2′75″N, the access is denied by the location-specific rule R-39. As mentioned above, such location coordinate need not necessarily be the actual longitude/latitude coordinates but can also depict the street, city, district, state, country of the device making the request along with parameters/attributes such as density of the location, purpose of the location, dynamics of the location, distance of the location from where the secured server carrying the resource is located, among other like information.

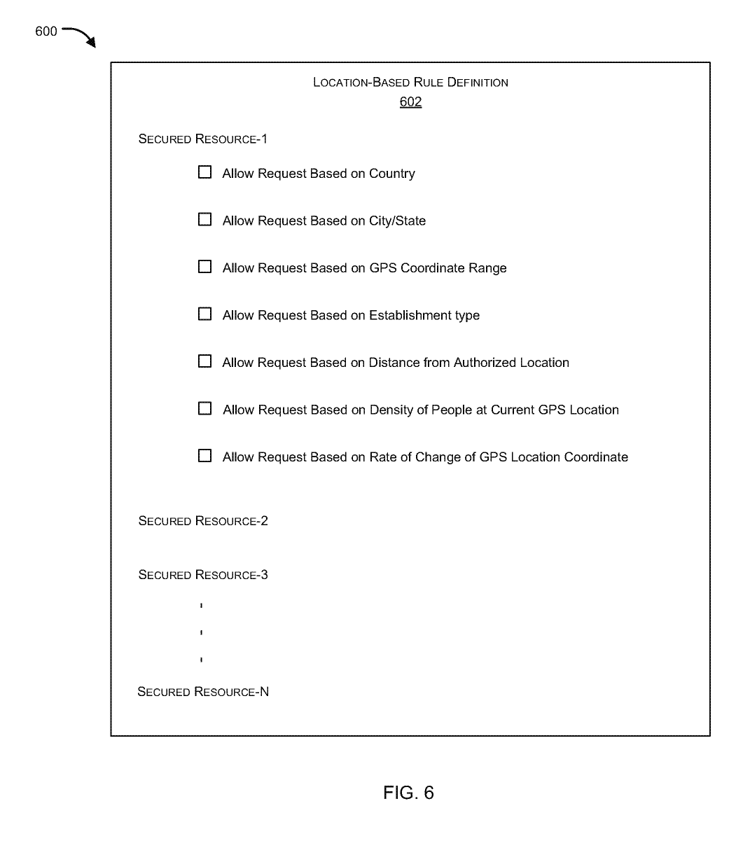

FIG. 6 illustrates an exemplary location based security rule configuration/definition screen 600 for secured network resources in accordance with an embodiment of the present disclosure. In the context of the present example, a location-specific rule can be defined by an authorized person of an organization, such as an administrator who can, for one or more protected resources made available within a network, define one or more rules indicating the conditions under which the resource at issue can be accessed. Such conditions need not necessarily be limited to location-specific conditions but can also include conditions that are user-specific, rights-specific, time of access specific, duration-specific, previous history specific, usage pattern specific, among other criteria.

For each secured/protected resource, such as Resource-1, Resource-2, Resource-3, . . . , Resource-N, an administrator can define whether the resource can be accessed based on the country from where the device is requesting access, state/city/district/street from where the device is requesting access, range of GPS coordinates that should be allowed access, distance from a defined/desired/authorized location that should be allowed access, density of people at the location where the requesting device is located, range of change of location of the device making the request, among other like parameters/factors. Those skilled in the art will appreciate that above-mentioned parameters are merely exemplary in nature and other parameter may be included/incorporated to define/configure location-specific rules.

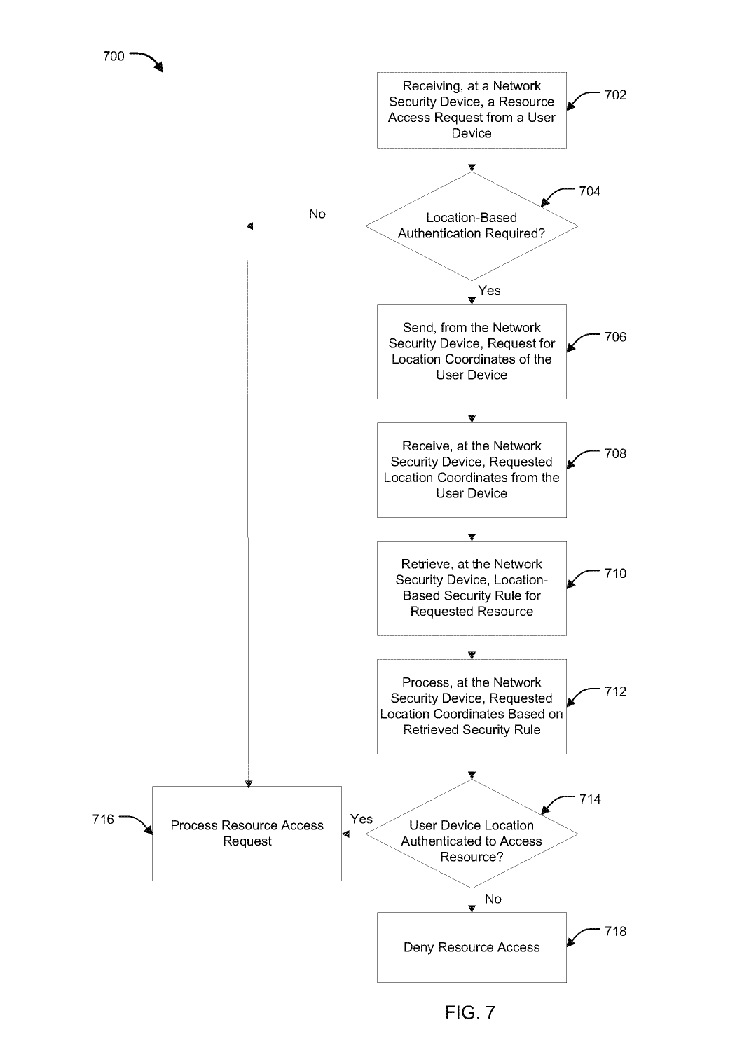

FIG. 7 is a flow diagram illustrating resource access request processing in accordance with an embodiment of the present disclosure. At step 702, the network security device receives a resource access request from a user device. At step 704, it is determined whether location-based authentication is required for the received resource access request. If no location-specific authentication is required, processing branches to block 716 and the user device making the request is allowed access. On the other hand, if it is determined that location-based authentication is required, the processing continues with block 706, at which the network security device issues a request for the location coordinates of the requesting user device, which are received at the network security device from the user device at step 708. At step 710, network security device can be configured to retrieve one or more location-specific rules that corresponds to the resource at issue, and at 712, the received location coordinates are processed in view of the retrieved rule(s) to determine at 714 whether the rule allows the user device to access the resource based on the current location of the user device. If the conditions of the one or more location-specific rules are satisfied, then processing continues with block 716 where the resource access request is processed; otherwise, processing branches to block 718 where access to the resource is denied.

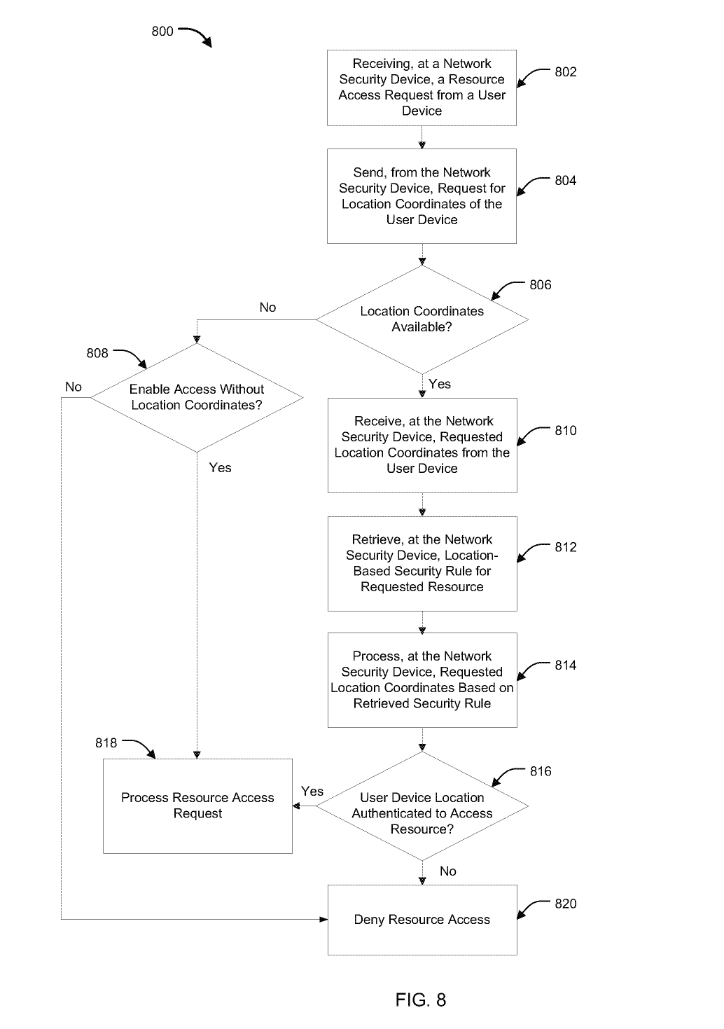

FIG. 8 is a flow diagram illustrating resource access request processing in accordance with another embodiment of the present disclosure. At step 802, the network security device receives a resource access request from a user device. At step 804, the security device can be configured to send a request to the user device for the location coordinates of the user device. At step 806, it is determined whether location coordinates are available from user device, wherein, in case the location coordinates are not available, it is determined at step 808 as to whether access to the requested resource can be allowed without the location coordinates. In case no access can be given without the location coordinates, the method flows to step 820 where the resource access is denied, whereas, in case access can be given without the location coordinates, the method goes to 818 where the resource access request can be processed. On the other hand, in case it is determined that location coordinates are available, the network security device receives the location coordinates from the user device at step 810 and retrieves location-specific rule that corresponds to the resource intended to be accessed by the user device at step 812, and at 814, processes the received location coordinates in view of the retrieved rule to determine at 816 as to whether the rule allows the user device at received location coordinates to access the requested resource, wherein in case the allowance is issued, the resource access request is processed at 818 else, the access is denied at 820.

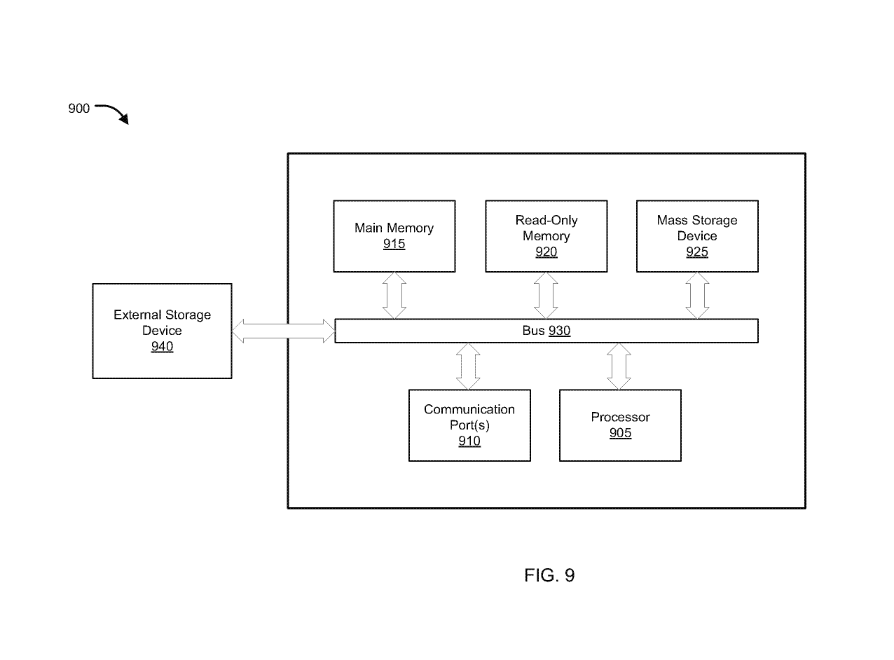

FIG. 9 is an example of a computer system 900 with which embodiments of the present disclosure may be utilized. Computer system 900 may represent or form a part of a network security device (e.g., firewall 204), a gateway or other rule-based network appliance. Embodiments of the present disclosure include various steps, which have been described above. A variety of these steps may be performed by hardware components or may be tangibly embodied on a computer-readable storage medium in the form of machine-executable instructions, which may be used to cause a general-purpose or special-purpose processor programmed with instructions to perform these steps. Alternatively, the steps may be performed by a combination of hardware, software, and/or firmware. As shown, computer system 900 includes a bus 930, a processor 905, communication port 910, a main memory 915, a removable storage media 940, a read only memory 920 and a mass storage 925. A person skilled in the art will appreciate that computer system 900 may include more than one processor and communication ports. Examples of processor 905 include, but are not limited to, an Intel® Itanium® or Itanium 2 processor(s), or AMD® Opteron® or Athlon MP® processor(s), Motorola® lines of processors, FortiSOC™ system on a chip processors or other future processors. Processor 905 may include various modules associated with embodiments of the present invention. Communication port 910 can be any of an RS-232 port for use with a modem based dialup connection, a 10/100 Ethernet port, a Gigabit or 10 Gigabit port using copper or fiber, a serial port, a parallel port, or other existing or future ports. Communication port 910 may be chosen depending on a network, such a Local Area Network (LAN), Wide Area Network (WAN), or any network to which computer system 900 connects. Memory 915 can be Random Access Memory (RAM), or any other dynamic storage device commonly known in the art. Read only memory 920 can be any static storage device(s) such as, but not limited to, a Programmable Read Only Memory (PROM) chips for storing static information such as start-up or BIOS instructions for processor 905. Mass storage 925 may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces), such as those available from Seagate (e.g., the Seagate Barracuda 7200 family) or Hitachi (e.g., the Hitachi Deskstar 7K1000), one or more optical discs, Redundant Array of Independent Disks (RAID) storage, such as an array of disks (e.g., SATA arrays), available from various vendors including Dot Hill Systems Corp., LaCie, Nexsan Technologies, Inc. and Enhance Technology, Inc. Bus 930 communicatively couples processor(s) 905 with the other memory, storage and communication blocks. Bus 930 can be, such as a Peripheral Component Interconnect (PCI)/PCI Extended (PCI-X) bus, Small Computer System Interface (SCSI), USB or the like, for connecting expansion cards, drives and other subsystems as well as other buses, such a front side bus (FSB), which connects processor 905 to software system. Optionally, operator and administrative interfaces, such as a display, keyboard, and a cursor control device, may also be coupled to bus 930 to support direct operator interaction with computer system 900. Other operator and administrative interfaces can be provided through network connections connected through communication port 910. Removable storage media 940 can be any kind of external hard-drives, floppy drives, IOMEGA® Zip Drives, Compact Disc—Read Only Memory (CD-ROM), Compact Disc—Re-Writable (CD-RW), Digital Video Disk—Read Only Memory (DVD-ROM). Components described above are meant only to exemplify various possibilities. In no way should the aforementioned exemplary computer system limit the scope of the present disclosure.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. Within the context of this document terms “coupled to” and “coupled with” are also used euphemistically to mean “communicatively coupled with” over a network, where two or more devices are able to exchange data with each other over the network, possibly via one or more intermediary device.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc. The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

While embodiments of the present disclosure have been illustrated and described, it will be clear that the disclosure is not limited to these embodiments only. Numerous modifications, changes, variations, substitutions, and equivalents will be apparent to those skilled in the art, without departing from the spirit and scope of the disclosure, as described in the claim.

What is claimed is:

1. A location-based network security system comprising:
one or more processors; and
a non-transitory storage device coupled to the one or more processors and having embodied therein instructions representing:
a request receive module, which when executed by the one or more processors receives a resource access request from a user device relating to a resource within a protected network that is protected by the location-based network security system;
a location determination module, which when executed by the one or more processors determines a geographical location of the user device;
a request-based rule retrieval module, which when executed by the one or more processors retrieves a location-specific security rule for the resource;
a location-based authorization module, which when executed by the one or more processors authenticates the resource access request based on application of the location-specific security rule to the determined geographical location; and
a resource access module, which when executed by the one or more processors enables access to the resource by the user device based on an affirmative authentication of the resource by the location-based authorization module.

2. The location-based network security system of claim 1, wherein the geographical location of the user device is determined based on a location request sent by the network security device to the user device asking for Global Positioning System (GPS) coordinates of the user device.

3. The location-based network security system of claim 1, wherein the geographical location of the user device is sent by the user device concurrently with the resource access request.

4. The location-based network security system of claim 1, wherein location-specific security rule comprises one or more conditions for allowing access to the resource based on one or a combination of a country from which the resource access request is issued, a state from which the resource access request is issued, a city from which the resource access request is issued, a type of establishment from which the resource access request is issued, a rate of change of location of the user device, a density of people in which the user device is currently located, a distance of a location from which the resource access request is issued from a defined location, and GPS coordinates of the user device.

5. The location-based network security system of claim 1, wherein the geographical location of the user device is determined based on one or a combination of triangulation, GPS, and geo-location mapped Internet Protocol (IP) addresses.

6. The location-based network security system of claim 1, wherein when the geographical location is not determinable, the location-based network security device denies access by the user device to the resource. The location-based network security system of claim 1, wherein the location-specific security rule is configurable to allow one or more user devices to access the resource regardless of their geographical locations.

8. The location-based network security system of claim 1, wherein the geographical location of the user device is provided to the location-based network security device by an application running on the user device.

9. The location-based network security system of claim 8, wherein the application authenticates a user of the user device before providing the geographical location to the location-based network security device.

10. The location-based network security system of claim 1, wherein the user device periodically sends keep-alive messages indicating a current geographical location of the user device to enable continuous reevaluation of the location-specific security rule by the location-based network security device.

11. The location-based network security system of claim 1, wherein the resource access module is further defines parameters of access given to the user device, wherein the parameters comprise one or a combination of privileges assigned to the user device during the access, duration of access, and frequency of keep-alive messages expected.

12. The location-based network security system of claim 1, wherein the location-based network security system comprises a firewall.
